(19) United States
(12) Patent Application Publication
(10) Pub. No.: US 2026/0120176 A1
(43) Pub. Date: Apr. 30, 2026

(54) Video Diffusion Model For Virtual Try-On

(71) Applicant: Google LLC, Mountain View, CA (US)

(72) Inventors: Yingwei Li, San Jose, CA (US); Johanna Suvi Karras, Seattle, WA (US); Irena Kemelmaher, Seattle, WA (US); Andreas Franz Lugmayr, New York, NY (US); Christopher Albert Lee, New York, NY (US); Innfarn Yoo, Fremont, CA (US); Nan Liu, New York, NY (US); Luyang Zhu, Seattle, WA (US)

(21) Appl. No.: 19/371,788

(22) Filed: Oct. 28, 2025

Related U.S. Application Data
(60) Provisional application No. 63/712,920, filed on Oct. 28, 2024.

(51) Int. Cl. G06Q 30/0601; G06V 10/30; G06V 10/82; G06V 40/10

(52) U.S. Cl. CPC G06Q 30/06432; G06V 10/30; G06V 10/82; G06V 40/10

(57) ABSTRACT

Provided are systems and methods for systems and methods for video virtual try-on with machine-learned video diffusion models. In particular, given an input garment image and person video, example systems and methods of the present disclosure operate to generate a high-quality try-on video of the person wearing the given garment, while preserving the person's identity and motion.

### RELATED APPLICATIONS

This application claims priority to and the benefit of U.S. Provisional Patent Application No. 63/712,920, filed Oct. 28, 2025, and titled Video Diffusion Model For Virtual Try-On. U.S. Provisional Patent Application No. 63/712,920 is hereby incorporated by reference in its entirety, including the Appendix thereto.

### FIELD

The present disclosure relates generally to machine learning models. More particularly, the present disclosure relates to machine learning models for video virtual try-on.

### BACKGROUND

Given a garment image and a person image, the computer vision task of virtual try-on aims to generate synthetic imagery that depicts how the person would look wearing the given garment. A particular subset of virtual try-on is video virtual try-on, where the input is a garment image and person video. Video virtual try-on (VVT) seeks to create a video containing multiple, visually consistent image frames that depict how a garment looks at different angles and how it drapes and flows in motion.

VVT is a technically challenging task use case. It requires synthesizing realistic try-on frames from different viewpoints, while generating realistic fabric dynamics (e.g. folds and wrinkles) and maintaining temporal consistency between frames. Additional difficulty arises if the person and garment poses vary significantly, as this creates occluded garment and person regions that need to be synthesized without prior knowledge of their details. Another challenge is the scarcity of try-on video data. Perfect ground truth data (i.e. two videos of different people wearing the same garment and moving in the exact same way) is difficult and expensive to acquire. In general, available human video data are more scarce and less diverse than image data.

Past approaches to virtual try-on typically leverage dense flow fields to explicitly warp the source garment pixels onto the target person frames. However, these flow-based approaches can introduce artifacts due to occlusions in the source frame, large pose deformations, and inaccurate flow estimates. Moreover, these methods are incapable of producing realistic and fine-grained fabric dynamics, such as wrinkling, folding, and flowing, as these details are not captured by appearance flows.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method for performing virtual try-on with split classifier-free guidance. The computer-implemented method can be performed for one or more diffusion timesteps. The method includes processing, by a computing system may include one or more computing devices, a noisy input associated with the diffusion timestep with a machine-learned diffusion model to generate an initial prediction. The method also includes setting, by the computing system, a current prediction equal to the initial prediction. The method also includes, for each of a plurality of update iterations respectively associated with a plurality of sets of one or more conditioning inputs: processing, by the computing system, the noisy input with the machine-learned diffusion model conditioned on the set of one or more conditioning inputs associated with the current update iteration to generate a conditioned prediction; updating, by the computing system, the current prediction based on the conditioned prediction associated with the current update iteration; and providing, by the computing system, an output image based on the current prediction, where the output image depicts a person wearing a garment. Other embodiments of this aspect include corresponding computer systems, apparatus, and computer programs recorded on one or more computer storage devices, each configured to perform the actions of the methods.

Implementations may include one or more of the following features. The computer-implemented method of claim 1, where: the method further may include obtaining a plurality of weights respectively associated with the plurality of sets of one or more conditioning inputs; and updating, by the computing system, the current prediction based on the conditioned prediction may include updating, by the computing system, the current prediction based on the conditioned prediction and according to the weight associated with the set of one or more conditioning inputs. Updating, by the computing system, the current prediction based on the conditioned prediction may include: determining, by the computing system, a weighted difference between the conditioned prediction associated with the current update iteration and the conditioned prediction associated with a prior preceding update iteration; and adding, by the computing system, the weighted difference to the current prediction. The noisy input may include a plurality of noisy inputs and the output image may include a plurality of output images; the plurality of output images may depict the person wearing the garment in motion; and the machine-learned diffusion model may include a video diffusion model. Each of the plurality of update iterations may include adding the set of one or more conditioning inputs to an active set of conditioning inputs. The plurality of sets of one or more conditioning inputs may include: a set of one or more clothing-agnostic images that depict the person agnostic of clothing; a set of one or more garment conditioning inputs that describe the garment; and a set of one or more pose or mask inputs associated with the person. The set of one or more garment conditioning inputs may include segmentation, pose, and mask inputs associated with the garment. The plurality of sets of one or more conditioning inputs may be added and processed by the model in the following order: (1) the set of one or more clothing-agnostic images that depict the person agnostic of clothing (e.g., show portions of the person's body that would be visible while wearing clothing, such as their feet, hands, face, etc.); (2) the set of one or more garment conditioning inputs that describe the garment; and (3) the set of one or more pose or mask inputs associated with the person. Implementations of the described techniques may include hardware, a method or process, or computer software on a computer-accessible medium.

One general aspect includes a computing system for training a diffusion model for virtual video try-on. The computing system also includes one or more processors. The system also includes one or more non-transitory computer-readable media that collectively store computer-executable instructions for performing operations, the operations may include: first training the diffusion model to generate denoised single images. The operations may include second training, over a plurality of training epochs, the diffusion model to generate videos which may include multiple denoised images. The operations may also include where, for at least one of the plurality of training epochs, a number of denoised images contained in the generated videos is increased relative to the previous training epoch. Other embodiments of this aspect include corresponding computer systems, apparatus, and computer programs recorded on one or more computer storage devices, each configured to perform the actions of the methods.

Implementations may include one or more of the following features. The computing system where a length of the generated videos is increased over the plurality of training epochs from 8 to 16 to 64. The first training to generate denoised single images may include a batch size greater than one and where the second training to generate videos may include a batch size of one. The second training further may include interspersed epochs of training the diffusion model to generate denoised single images.

One general aspect includes one or more non-transitory computer-readable media storing a machine-learned video diffusion model that has been trained using a progressive temporal training technique in which the number of output images is increased as training progresses. The machine-learned video diffusion model may have been trained using a joint image and video training technique in which the machine-learned video diffusion model is jointly trained on both image batches and video batches. Implementations of the described techniques may include hardware, a method or process, or computer software on a computer-accessible medium.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a graphical diagram of an example machine learning model performing video virtual try-on according to example embodiments of the present disclosure.

FIG. 2 depicts a graphical diagram of an example machine learning model architecture according to example embodiments of the present disclosure.

FIG. 3 depicts a flow chart diagram of an example method to perform split-classifier free guidance according to example embodiments of the present disclosure.

FIG. 4 depicts a flow chart diagram of an example method to perform progressive temporal training according to example embodiments of the present disclosure.

FIG. 5A depicts a block diagram of an example computing system according to example embodiments of the present disclosure.

FIG. 5B depicts a block diagram of an example computing device according to example embodiments of the present disclosure.

FIG. 5C depicts a block diagram of an example computing device according to example embodiments of the present disclosure.

Reference numerals that are repeated across plural figures are intended to identify the same features in various implementations.

### DETAILED DESCRIPTION

Generally, the present disclosure is directed to systems and methods for video virtual try-on with machine-learned video diffusion models. In particular, given an input garment image and person video, example systems and methods of the present disclosure operate to generate a high-quality try-on video of the person wearing the given garment, while preserving the person's identity and motion. Image-based virtual try-on has shown impressive results; however, existing video virtual try-on (VVT) methods are still lacking garment details and temporal consistency. To address these issues, the present disclosure provides a diffusion-based architecture for VVT, split classifier-free guidance for increased control over the conditioning inputs, and a progressive temporal training strategy for generating output videos. As one example, the proposed model can operate in a single inference pass to generate a 64-frame, 512 px video. The present disclosure also demonstrates the effectiveness of joint image-video training for video try-on, especially when video data is limited.

More particularly, the present disclosure provides techniques which enable a computing system to leverage a diffusion model for generating output videos for a VVT task. In general, diffusion models have shown promising results on various video synthesis tasks, such as text-to-video generation and image-to-video generation. However, a key challenge is generating longer videos, while maintaining temporal consistency and adhering to computational and memory constraints. For example, directly applying a single-image-based diffusion model for VVT in a frame-by-frame manner can result in severe flickering artifacts and temporal inconsistencies.

Previous works use cascaded approaches, sliding windows inference, past-frame conditioning, and transitions or interpolation. Yet, even with such schemes, longer videos are temporally inconsistent, contain artifacts, and lack realistic textures and details.

Another potential option for diffusion-based VVT is to apply an animation model to a single try-on image generated by an image try-on model. However, as this is not an end-to-end trained system, any image try-on errors will accumulate throughout the video without correction.

Instead, the present disclosure proposes that short-video generation models can be extended for long-video generation by a temporally progressive finetuning scheme, without introducing additional inference passes or multiple networks. Furthermore, the present disclosure proposes that a single VVT model can overcome issues associated with accumulated errors by 1) injecting explicit person and garment conditioning information into the model and 2) having an end-to-end training objective.

Example implementations of the present disclosure can be referred to as Fashion-VDM, which represents the first VVT method to synthesize temporally consistent, high-quality try-on videos, even on diverse poses and difficult garments. Some example implementations of Fashion-VDM can include or leverage a single-network, diffusion-based approach. To maintain temporal smoothness, some example implementations can inflate a single-image-diffusion architecture with 3D-convolution and temporal attention blocks. Some example implementations can maintain temporal consistency in longer videos (e.g., 64-frames long) with a single network by training in a temporally progressive manner.

To address input person and garment fidelity, some example implementations can perform split classifier-free guidance (split-CFG) that enables increased control over each input signal. Split-CFG increases realism, temporal consistency, and garment fidelity, compared to ordinary or dual CFG.

Additionally, some example implementations can increase garment fidelity and realism by training jointly with image and video data. Example results contained in the Appendix show that example implementations of Fashion-VDM surpass benchmark methods by a large margin and synthesizes state-of-the-art try-on videos.

The systems and methods of the present disclosure provide a number of technical effects and benefits in the field of image processing, computer vision, and virtual garment try-on technology.

One example technical effect of the present disclosure is improved quality, accuracy, and/or realism of generated synthetic virtual try-on videos. Generating a synthetic video that accurately and consistently depicts a person wearing a garment in motion is a challenging computer vision task. The proposed techniques enable a video diffusion model to generate such a video with improved quality, which represents an improvement to the capability and performance of a computing system.

Another example technical effect of the present disclosure results from the ability to generate videos using a unified (non-cascading) architecture. Specifically, past approaches often relied upon a cascading or multi-model approach and/or relied upon performing multiple inference runs over different time windows or refinements. Running multiple models and/or multiple inference runs consumes significant amounts of computational resources such as processor cycles, memory usage, network bandwidth, etc. By replacing these approaches with a unified architecture with single inference run, the proposed techniques can reduce the consumption of computational resources such as processor cycles, memory usage, network bandwidth, etc.

With reference now to the Figures, example embodiments of the present disclosure will be discussed in further detail.

### Example VVT Task Illustration

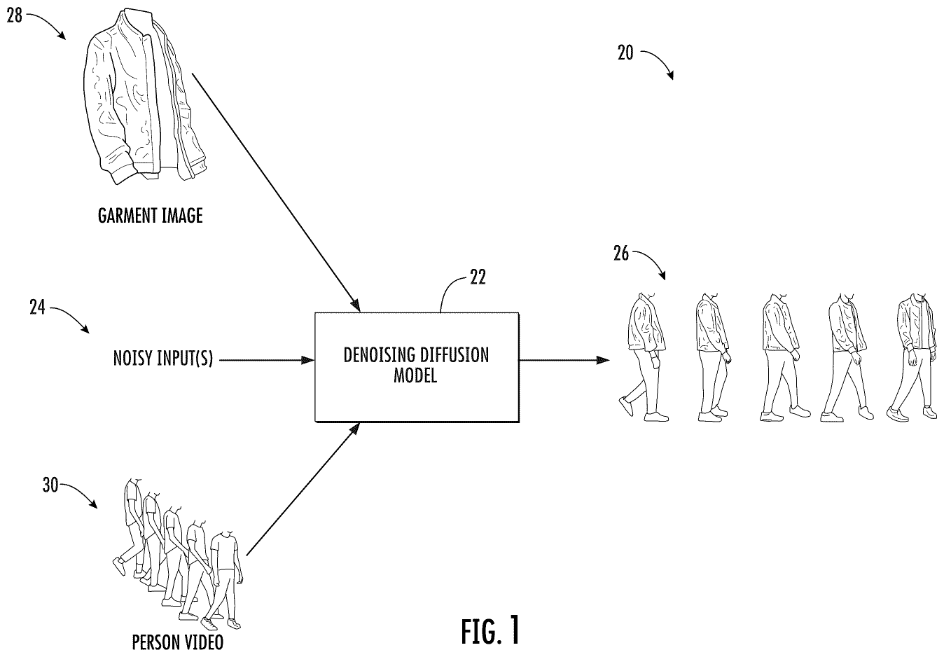

FIG. 1 depicts a graphical diagram of an example machine learning model performing VVT according to example embodiments of the present disclosure. The example machine learning model includes a diffusion model 22. The diffusion model 22 can be configured to receive one or more noisy inputs 24 and generate a plurality of output images 26.

In some implementations, the one or more noisy inputs 24 comprise a plurality of noisy input images. Each noisy input image can include pixel values that comprise random noise values. In other implementations, the noisy inputs 24 can include one or more noisy latent inputs expressed in a learned latent space.

The diffusion model 22 can also receive one or more conditioning inputs. The conditioning inputs can include a garment image 28 that depicts a garment. In the illustrated example, the garment image depicts a leather jacket. The conditioning inputs can include a person video 30. The person video 30 can include a plurality of frames that depict a person. The person can be in motion over the frames. That is, when the frames are displayed sequentially, the person can be appear to move according to a motion (e.g., the video can be a “movie”). In the person video 30, the person is not wearing the garment depicted in the garment image 28. For example, in the illustrated person video 30, the person is wearing a t-shirt.

The output images 26 can be a video of the person wearing the garment. The output images 26 can be generated by the diffusion model 22 based on the noisy input(s) 24 and the one or more conditioning inputs, such as the garment image 28 and the person video 30. The conditioning inputs 28 and 30 can be processed to generate segmentation data, masks, and/or pose data. The segmentation data, masks, and/or pose data can be used by the diffusion model 22 to generate the output images 26.

In some examples, the person video 30 is a video

$$\{ {I}_{p}^{0} , {I}_{p}^{1} , … , {I}_{p}^{N - 1} \}$$

of a person p consisting of N frames and the garment image 28 is a single garment image I_{g} of another person wearing garment g. In some implementations, the garment image can have the portions of that depict the portion removed so that only the garment remains. The diffusion model 22 can synthesize an output video

$$26 \{ {I}_{tr}^{0} , {I}_{tr}^{1} , … , {I}_{tr}^{N - 1} \} , where {I}_{tr}^{i}$$

denotes the i-th try-on video frame that preserves the identity and motion of the person p wearing the garment g.

In some implementations, the diffusion model 22 can be a single-network, diffusion-based architecture. The diffusion model 22 can be configured to operate over a number of diffusion timesteps. The diffusion model 22 can be configured to generate a denoised version of a respective set of noisy input(s) at each of the diffusion timesteps. The number of diffusion timesteps can be any suitable number, including 1 timestep, 2 timesteps, or any number N of diffusion timesteps (e.g., 1000 diffusion timesteps).

### Example Model Architecture

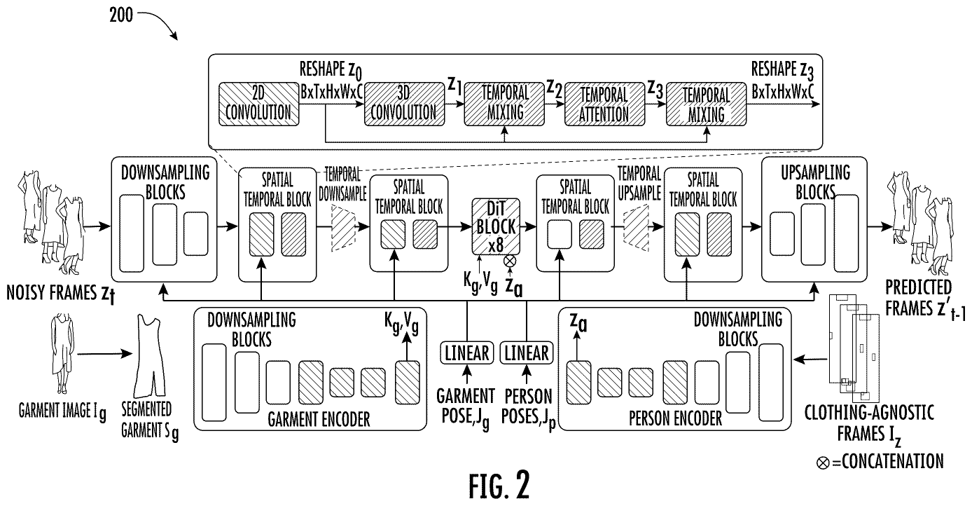

FIG. 2 depicts a graphical diagram of one specific example machine learning model architecture 200 according to example embodiments of the present disclosure. This architecture is provided as one possible example architecture. Other architectures could be used alternatively.

The example network architecture 200 is similar to the VTO-UDiT architecture described in U.S. Provisional Patent Application No. 63/616,294 and U.S. patent application Ser. No. 19/003,906, which is a state-of-the-art multi-garment image try-on diffusion model that also enables text-based control of garment layout. U.S. Provisional Patent Application No. 63/616,294 and U.S. patent application Ser. No. 19/003,906 are hereby incorporated by reference herein. VTO-UDiT can be represented by:

$${\hat{x}}_{0} = {x}_{θ} ( {z}_{t} , t , {c}_{tr} ) \qquad ( 1 )$$

where \hat{x}₀ is the predicted try-on image by the network x_{θ}, parameterized by θ, at diffusion timestep t, zₜ is the noisy image, and cₜᵣ is the conditioning inputs. VTO-UDiT is parameterized in v-space; however, a latent diffusion model could also be used to implement aspects of the present disclosure.

Each conditioning input can be encoded separately by fully convolutional encoders and processed at the lowest resolution of the main UNet via DiT blocks, where conditioning features are processed with self-attention or cross-attention modules. While the base VTO-UDiT model shows impressive results for image try-on, the present disclosure provides techniques which enable the model to reason about temporal consistency when applied to video inputs.

From the input video frames, the example architecture 200 can compute the clothing-agnostic frames

$${I}_{a} = \{ {I}_{a}^{0} , {I}_{a}^{1} , … , {I}_{a}^{N - 1} \} ,$$

person poses

$${J}_{p} = \{ {J}_{p}^{0} , {J}_{p}^{1} , … , {J}_{p}^{N - 1} \} ,$$

and person masks

$$\{ {M}_{p}^{0} , {M}_{p}^{1} , … , {M}_{p}^{N - 1} \} .$$

The clothing-agnostic frames can mask out the entire bounding box area of the person in the frame, except for the visible body regions (head, hands, legs, and shoes). Optionally, the clothing-agnostic frames can keep the original bottoms, if doing top try-on only. From the input garment image I_{g}, the architecture 200 can extract the garment segmentation image S_{g}, garment pose J_{g}, and garment mask M_{g}. The garment pose can refer to the pose keypoints of the person wearing the garment before segmentation. Poses, masks, and segmentations can be computed using universal human parsing agent. One such agent is described in Gong et al., Graphonomy: Universal Human Parsing via Graph Transfer Learning, arXiv:1904.04536 [cs.CV]. Both person and garment pose keypoints can also be preprocessed to be spatially aligned with the person frames and garment image, respectively.

As noted above, the example architecture 200 is similar to the VTO-UDiT architecture described in U.S. Provisional Patent Application No. 63/616,294 and U.S. patent application Ser. No. 19/003,906. The architecture 200 can be achieved by inflating the two lowest-resolution downsampling and upsampling blocks with temporal attention and 3D-Conv blocks. To be specific, after the 2D-Conv layers, some example implementations can add a 3D-Conv block, a temporal attention block, and a temporal mixing block to linearly combine spatial and temporal features. In the temporal mixing blocks, processed features after the spatial attention layer zₛ can be linearly combined with processed features after the temporal attention layer zₜ via learned weighting parameter α:

$${z}_{t}^{′} = α \cdot {z}_{s} + ( 1 - α ) \cdot {z}_{t} \qquad ( 2 )$$

In some implementations, during some portions of model training (e.g., 64-frame training), the model can be further inflated with temporal downsampling and upsampling blocks with factor 2, to reduce the memory footprint of the model. These blocks can be added before and/or after the lowest-resolution spatial blocks, respectively.

The person and garment poses can be encoded and used to condition all 2D spatial layers in the UNet. The 8 Diffusion Transformer (DiT) blocks between the UNet encoder and decoder condition the model on the segmented garment and clothing-agnostic image features. In each block, the garment images can be cross-attended with the noisy target features, while the agnostic input images are concatenated to the noisy target features.

Thus, with reference to FIG. 2, given a noisy video zₜ at diffusion timestep t, a forward pass of the diffusion model computes one or more denoising steps (e.g., a single denoising step) to get the denoised video

$${z}_{t + 1}^{′} .$$

The input zₜ can be preprocessed into person poses Jₚ and clothing-agnostic frames Iₐ, while the garment image I_{g} can be preprocessed into garment segmentation S_{g} and garment poses J_{g}. The example architecture 200 can be similar to the architecture described in U.S. Provisional Patent Application No. 63/616,294, except that the main UNet contains 3D-Cony and temporal attention blocks to maintain temporal consistency. Additionally, some example implementations inject temporal down/upsampling blocks during 64-frame temporal training. zₜ can be encoded by the main UNet and the conditioning signals, S_{g} and Iₐ can be encoded by separate UNet encoders. In the 8 DiT blocks at the lowest resolution of the UNet, the garment conditioning features can be cross-attended with the noisy video features and the spatially-aligned clothing-agnostic features zₐ and noisy video features can be directly concatenated. J_{g} and Jₚ can be encoded by single linear layers, then concatenated to the noisy features in all UNet 2D spatial layers.

U.S. Provisional Patent Application No. 63/616,294 is hereby incorporated by reference in its entirety.

### Example Split-CFG Techniques

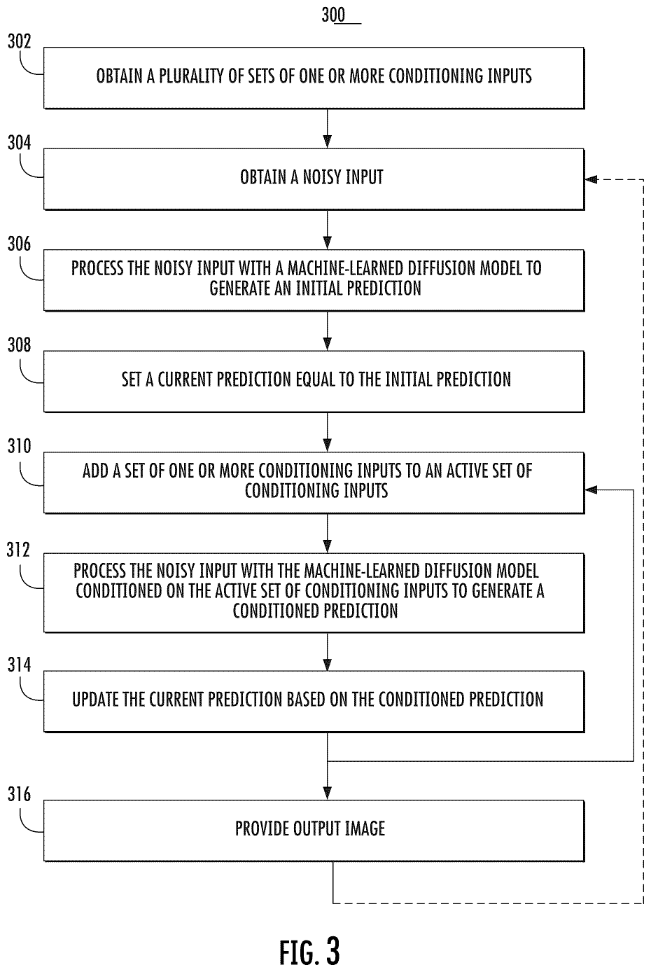

FIG. 3 depicts a flow chart diagram of an example method 300 to perform split-classifier free guidance according to example embodiments of the present disclosure. Method 300 can be repeated for any number of diffusion timesteps.

More particularly, standard classifier-free guidance (CFG) is a sampling technique that pushes the distribution of inference results towards the input conditioning signal(s); however, it does not allow for disentangled guidance towards separate conditioning signals. Another approach is dual-CFG, which separates the CFG weights for text and image conditioning signals.

The present disclosure introduces split-CFG, an approach which allows independent control over multiple conditioning signals. Algorithm 1 represents one example implementation. In particular, in some implementations, the inputs to Split-CFG can include the trained denoising model Ee, the list of all conditioning signal sets C, and the respective conditioning weights W. In some implementations, for each subset of conditioning signals cᵢ∈C, containing one or more conditional inputs, the computing system performing the split-CFG approach can compute the conditional result ϵᵢ given cᵢ. Then, in some implementations, the weighted difference between the conditional result ϵ_i from the past conditional result ϵᵢ₋₁ is added to the prediction. In this way, the prediction is pushed in the direction of cᵢ.

More particularly, referring now to FIG. 3, at 302, a computing system comprising one or more computing devices can obtain a plurality of sets of one or more conditioning inputs. The one or more conditioning inputs can include one or more images that depict a person. The one or more conditioning inputs can include one or more images that depict a garment.

At 304, the computing system can obtain a noisy input. The noisy input can be a single noisy image or a plurality of noisy images or can be a single noisy latent representation or a plurality of noisy latent representations.

At 306, the computing system can process the noisy input with a machine-learned diffusion model to generate an initial prediction. In some implementations, the initial prediction can be a single set of noise to remove from a single noisy input or can be a plurality of sets of noise to respectively remove from a plurality of noisy inputs. The initial prediction may be conditioned on a null set of conditioning inputs.

At 308, the computing system can set a current prediction equal to the initial prediction.

At 310, the computing system can add a set of one or more conditioning inputs to an active set of conditioning inputs.

At 312, the computing system can process the noisy input(s) with the machine-learned diffusion model conditioned on the active set of conditioning inputs associated with the current update iteration to generate a conditioned prediction. In some implementations, the conditioned prediction can be a single set of noise to remove from a single noisy input or can be a plurality of sets of noise to respectively remove from a plurality of noisy inputs.

At 314, the computing system can update the current prediction based on the conditioned prediction associated with the current update iteration. As one example, updating the current prediction at 314 can include updating the current prediction based on the conditioned prediction and according to a weight associated with the set of one or more conditioning inputs that were added to the active set at 310.

As one example, updating the current prediction at 314 can include determining a weighted difference between the conditioned prediction associated with the current update iteration and the conditioned prediction associated with a prior preceding update iteration, and adding the weighted difference to the current prediction.

In some implementations, after 314, the method 300 can return to step 310 to perform another update iteration. The steps 310-314 can be performed for any number of different update iterations which correspond to different sets of conditioning inputs.

In some implementations, the set of conditioning inputs that are added to the active set at each instance of step 310 can be retained within the active set throughout the remainder of method 300. In other implementations, the set of conditioning inputs that are added to the active set at each instance of step 310 can be removed from the active set before the method returns to step 310 for the next update iteration.

At 316, the computing system can provide an output image based on the current prediction. For example, the output image can include a denoised version of the noisy input image. For example, the current prediction may represent noise that, when removed from the noisy input, generates or otherwise results in the output image.

Thus, as one example, at 316, providing the output image can include removing the current prediction (e.g., which may represent predicted noise) from the noisy input image. For example, removing the current prediction can include subtracting the current prediction from the noisy input image.

As one example, the output image can depict a person wearing a garment. As one example, at 316, the computing system can provide the output image by providing a plurality of output images. The plurality of output images can depict the person wearing the garment in motion. In some implementations, rather than providing output images at 316, the method 300 can provide output latent representations which have been denoised.

In some implementations, method 300 can be iteratively performed over a number of diffusion timesteps. For example, the output provided at 316 for a particular diffusion timestep can serve as the noisy input at 304 for the subsequent diffusion timestep.

As noted above, Algorithm 1 represents one example implementation of the split-CFG technique described herein.

Algorithm 1: Split Classifier-Free Guidance

Split-CFG(∈_{θ}, C, W)

| \| | c ← ∅ | | | [symbol] current conditioning signals; |
|---|---|---|---|---|
| \| | \hat{∈}_{θ} (zₜ, C) ← w₀∈_{θ} (zₜ, ∅) | | | [symbol] initialize prediction; |
| \| | \hat{∈}₀ ← \hat{∈}_{θ} (zₜ, C) | | | [symbol] store past prediction; |
| \| | for cᵢ in C do | | | |
| \| | | \| | c ← c ∪ {cᵢ } | [symbol] update c; |
| \| | | \| | \hat{∈}ᵢ ← ∈_{θ} (zₜ, c) | [symbol] store new prediction; |
| \| | | \| | \hat{∈}_{θ} (zₜ, C) ← \hat{∈}_{θ} (zₜ, C) + wᵢ (\hat{∈}ᵢ − \hat{∈}ᵢ₋₁) ; | |
| \| | | \| | \hat{∈}ᵢ₋₁ ← \hat{∈}ᵢ | [symbol] update ∈ᵢ₋₁ |

| | |
|---|---|
| \| | end |
| \| | return \hat{∈}_{θ} (zₜ, C) |

Some implementations of Split-CFG may be dependent on the order of the conditioning signals. Intuitively, the first conditional output will have the largest distance from the null output, thus most affecting the final result. In some implementations, the conditioning groups C can include (1) the empty set (unconditional inference), (2) the clothing-agnostic images Iₐ, (3) all clothing-related inputs (S₉,J₉,M_{g}), and (4) lastly, all remaining conditioning inputs Iₚ, Mₚ, etc. Example respective weights of each term can be denoted as (w_{ø}, wₚ, w_{g}, w_{full}). This ordering can provide strong results.

Overall, controlling sampling via split-CFG not only enhances the frame-wise garment fidelity, but also increases photo-realism (FID) and the inter-frame consistency of video (FVD), compared to ordinary CFG.

### Example Progressive Temporal Training Techniques

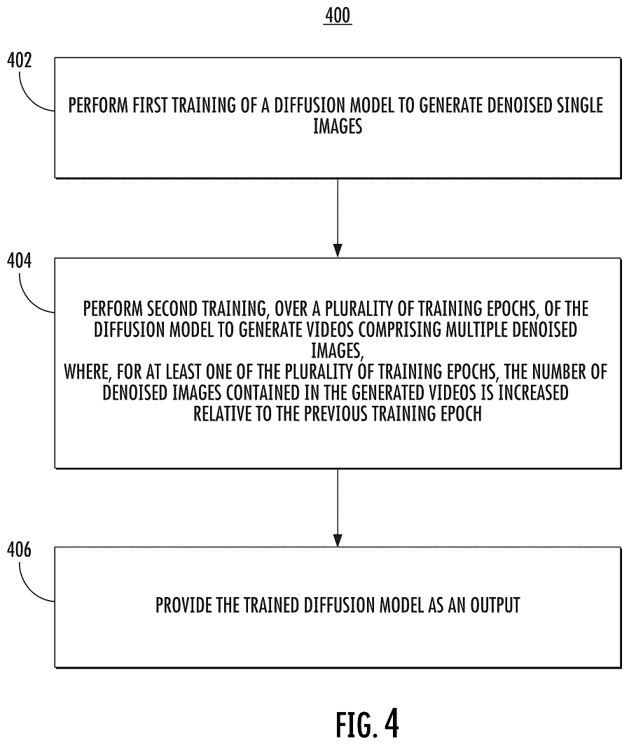

FIG. 4 depicts a flow chart diagram of an example method 400 to perform progressive temporal training according to example embodiments of the present disclosure.

In particular, example progressive temporal training techniques described herein enable the generation of relatively larger videos (e.g., 64 frames) in a single inference run. Some example implementations first train a base image model from scratch on image data at 512 px resolution and image batches of shape B×T×H×W×C, with, for example, batch size B=8 and length T=1, for some number (e.g., 1 million) of iterations. Then, the training system can inflate the base architecture with temporal blocks and continue training the same spatial layers and new temporal layers with image and video batches with, for example, batch size B=1 and length T=8.

Video batches can include consecutive frames of length T from the same video. After convergence, some example implementations double the video length T (e.g., to T=16). This process can be repeated until the system reaches a target length (e.g., 64 frames). Each temporal phase is trained for some number (e.g., 150 thousand) of iterations. The benefit of such a progressive process is a faster convergence speed and better multi-frame consistency.

More particularly, with specific reference now to FIG. 4, at 402, a computing system comprising one or more computing devices can perform first training of a diffusion model to generate denoised single images.

At 404, the computing system can perform second training, over a plurality of training epochs, of the diffusion model to generate videos comprising multiple denoised images. In some implementations, at 404, and prior to performing the second training, the computing system can add temporal blocks to the model architecture, or can otherwise “inflate” the model.

At 404, for at least one of the plurality of training epochs, the number of denoised images contained in the generated videos is increased relative to the previous training epoch. As one example, at 404, the number of denoised images contained in the generated videos is increased over the plurality of training epochs from 8 to 16 to 64.

As one example, at 402, the first training to generate denoised single images can include a batch size greater than one but with a video length of one. For example, during the first training, the model can simultaneously create multiple single images that do not depict the same content or are otherwise not structured as a temporally-consistent video. As one example, at 404, the second training to generate videos can include a batch size of one but with a video length of greater than one. For example, during the second training, the model can simultaneously create multiple images that depict the same content and which are structured as a single temporally-consistent video.

At 406, the computing system can provide the trained diffusion model as an output. For example, providing the model as an output can include storing the trained model, transmitting the trained model, deploying the trained model, and/or other actions.

In some implementations, at 404, the second training can further include interspersed epochs of training the diffusion model to generate denoised single images.

More particularly, training the temporal phases solely with video data, which is much more limited in scale compared to image data, may, in some circumstances, waste the image dataset entirely after the pretraining phase.

For example, video-only training in the temporal phases sacrifices image quality and fidelity for temporal smoothness. To combat this issue, some example implementations can train the temporal phases jointly with 50% image batches and 50% video batches.

Some example implementations can perform joint training via conditional network branching, i.e. for image batches, the system skips updating the temporal blocks in the network. Conditional network branching allows the computing system to include other temporal blocks (e.g., Conv-3D, temporal mixing) in addition to temporal attention.

Some example implementations also train with either image-only or video-only batches, rather than batches of video with appended images. This improves data diversity and training stability by not constraining the possible batches by the number of available video batches.

As compared to video-only training, joint image-video training can result in improved garment fidelity and multi-view realism, especially for synthesized details in occluded garment regions.

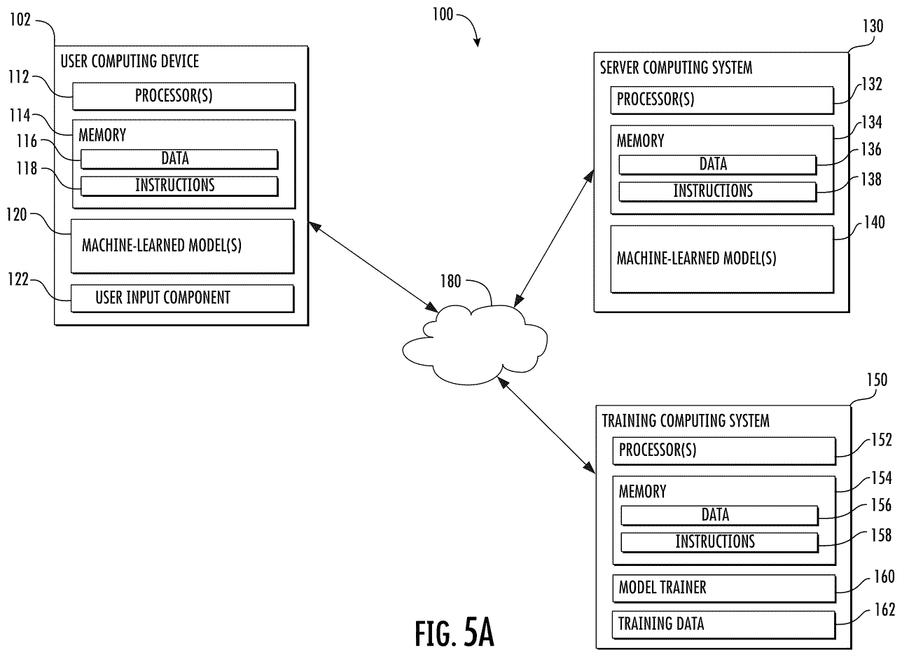

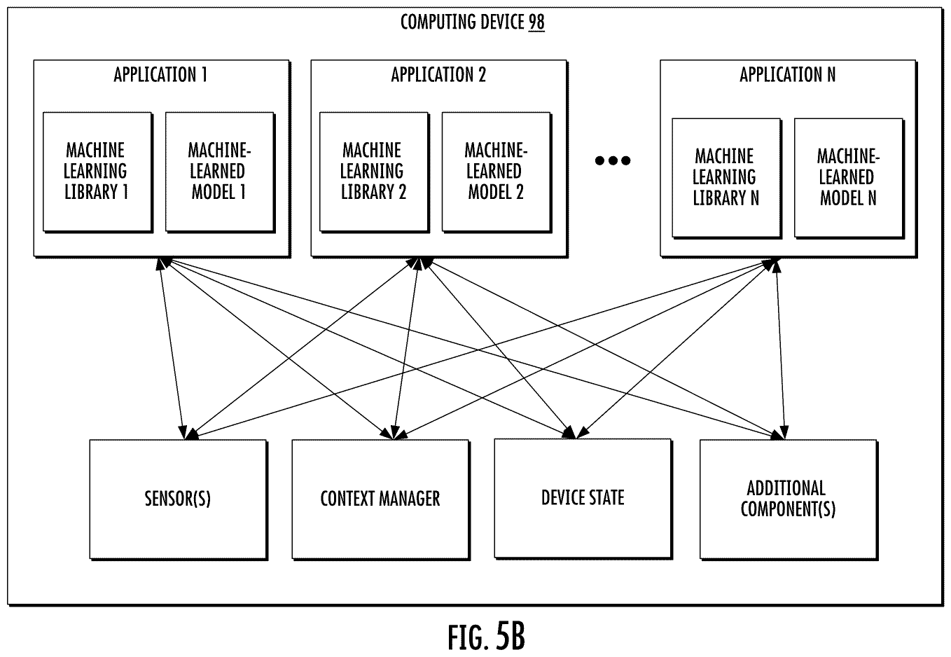

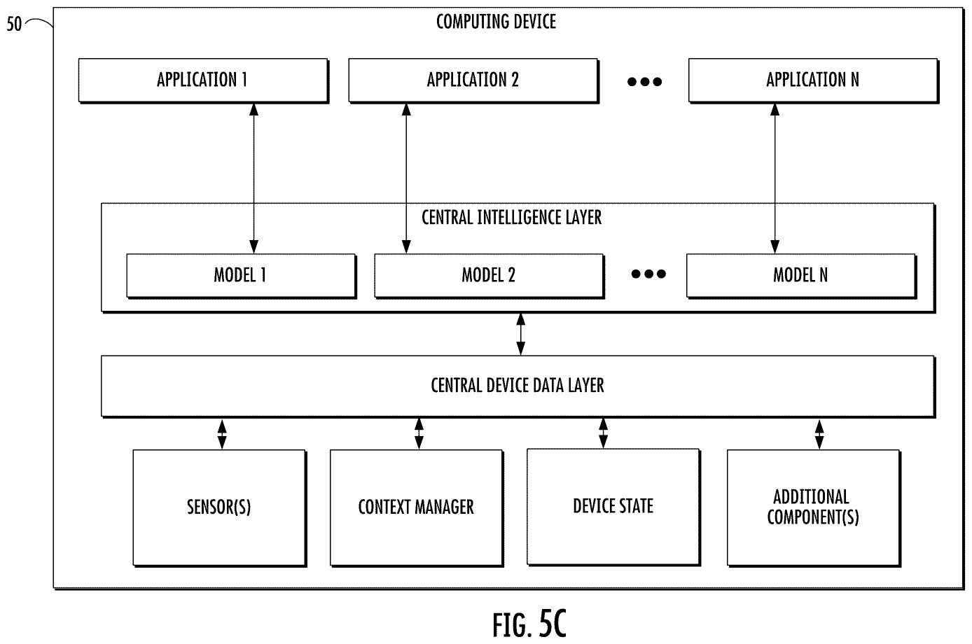

FIG. 5A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1-3.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel image generation across multiple instances of input sets).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., a virtual try-on service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-3.

One example type of machine learning model (e.g., model 120 and/or 140) is a denoising diffusion model (or “diffusion model”). A denoising diffusion model can be defined as a type of generative model that learns to progressively remove noise from a set of input data to generate new data samples. A comprehensive discussion of diffusion models is provided by Yang L., Zhang Z., Song Y., Hong S., Xu R., Zhao Y., Zhang W., Cui B., and Yang M., Diffusion Models: A Comprehensive Survey of Methods and Applications, arXiv:2209.00796 [cs.LG]. See also, Sohl-Dickstein, J., Weiss, E., Maheswaranathan, N., & Ganguli, S. (2015). Deep Unsupervised Learning using Nonequilibrium Thermodynamics. In International Conference on Machine Learning (ICML); Song, Y., & Ermon, S. (2019). Generative Modeling by Estimating Gradients of the Data Distribution. In Advances in Neural Information Processing Systems (NeurIPS); Ho, J., Jain, A., & Abbeel, P. (2020). Denoising Diffusion Probabilistic Models. In Advances in Neural Information Processing Systems (NeurIPS); and Song, Y., Sohl-Dickstein, J., Kingma, D. P., Kumar, A., Ermon, S., & Poole, B. (2020). Score-Based Generative Modeling through Stochastic Differential Equations. In International Conference on Learning Representations (ICLR).

More particularly, in some implementations, the diffusion process of a denoising diffusion model can include both forward and reverse diffusion phases. The forward diffusion phase can include gradually adding noise (e.g., Gaussian noise) to data over a series of time steps. This transformation can lead to the data eventually resembling pure noise. For example, in the context of image processing, an initially clear image can incrementally receive noise until it is indistinguishable from random noise. In some implementations, this step-by-step addition of noise can be parameterized by a variance schedule that controls the noise level at each step.

Conversely, the reverse diffusion phase can include systematically removing the noise added during the forward diffusion to reconstruct the original data sample or to generate new data samples. This phase can use a trained neural network model to predict the noise that was added (or conversely, that should be removed) at each step and subtract it from the noisy data. For instance, starting from a purely noisy image, the model can iteratively denoise the image, progressively restoring details until a clear image is obtained.

This process of reverse diffusion can be guided by learning from a set of training data, where the model learns the optimal way to remove noise and recover data. The ability to reverse the noise addition effectively allows the generation of new data samples that are similar to the training data and/or modified according to specified conditions. In particular, in the learned reverse diffusion process, the diffusion model can be used to generate new samples that can either produce new variations based on the learned data distribution or, through a deterministic sampling process, closely reconstruct an original sample from its noisy version. Due to the stochastic nature of the standard reverse process, a perfect pixel-for-pixel replication is generally not the goal; rather, the model generates a high-fidelity sample from the same distribution.

In some implementations, denoising diffusion models can operate in either pixel space or latent space, each offering distinct advantages depending on the application requirements. Operating in pixel space means that the model directly manipulates and generates data in its original form, such as raw pixel values for images. For example, when generating images, the diffusion process can add or remove noise directly at the pixel level, allowing the model to learn and reproduce fine-grained details that are visible in the pixel data.

Alternatively, operating in latent space can include transforming the data into a compressed, abstract representation before applying the diffusion process. This can be beneficial for handling high-dimensional data or for improving the computational efficiency of the model. For instance, an image can be encoded into a lower-dimensional latent representation using an encoder network, and the diffusion process can then be applied in this latent space. The denoised latent representation can subsequently be decoded back into pixel space to produce the final output image. This approach can reduce the computational load during the training and sampling phases and can sometimes help in capturing higher-level abstract features of the data that are not immediately apparent in the pixel space.

In some implementations, denoising diffusion models can utilize probability distributions to manage the transformation of data throughout the diffusion process. As one example, Gaussian distributions can be employed in the forward diffusion phase, where noise added to the data is typically modeled as Gaussian. This method can be beneficial for applications like image processing or audio synthesis, where the gradual addition of Gaussian noise helps in creating a smooth transition from original data to a noise-dominated state. However, the model can also be designed to use other types of noise distributions as part of its stochastic process.

In the reverse phase, learned transition distributions can guide the denoising steps. Specifically, a parameterized model (e.g., neural network) can be used to predict the noise to be removed at each step of the reverse phase.

Model parameters can refer to parameter values within the denoising diffusion model that can be learned from training data to optimize the performance of the denoising diffusion model. Model parameters can include the weights of the neural networks used to predict the noise in the reverse diffusion process. Other components, optionally set as fixed hyperparameters, include the parameters defining the noise schedule in the forward process (e.g., the variance at each step). While most models use a fixed, predefined schedule, some advanced implementations explore learning the schedule itself as part of the optimization.

The architecture of an example denoising diffusion model can include one or more neural networks. The neural networks can be trained to parameterize the transition kernels in the reverse Markov chain. As examples, the architecture of a denoising diffusion model can incorporate various types of neural networks, such as Convolutional Neural Networks (CNNs) or Recurrent Neural Networks (RNNs).

As a specific example, in some implementations, the neural network architecture can take the form of a U-Net. The U-Net architecture is characterized by its U-shaped structure, which includes a contracting path and an expansive path. The contracting path follows the typical architecture of a convolutional network, including repeated application of convolutions, followed by pooling operations that reduce the spatial dimensions of the feature maps. The expansive path of the U-Net, on the other hand, can include a series of up-convolutions and concatenations with high-resolution features from the contracting path. This can be achieved through skip connections that directly connect corresponding layers in the contracting path to layers in the expansive path.

More generally, the neural network architecture in denoising diffusion models can include multiple layers that can include various types of activation functions. These functions introduce non-linearities that enable the network to capture and learn complex data patterns effectively, although the specific choices of layers and activations can vary based on the model design and application requirements.

Additionally, the architecture can include special components like residual blocks and attention mechanisms, which can enhance the model's performance. Residual blocks can help in training deeper networks by allowing gradients to flow through the network more effectively. Attention mechanisms can provide a means for the model to focus on specific parts of the input data, which is advantageous for applications such as language translation or detailed image synthesis, where contextual understanding significantly impacts the quality of the output. These components are configurable and can be integrated into the neural network architecture to address specific challenges posed by the complexity of the data and the requirements of the generative task.

In some implementations, the training process of a denoising diffusion model can be oriented towards specific learning objectives. These objectives can include minimizing the difference between the original data and the data reconstructed after the reverse diffusion process. Specifically, in some implementations, an objective can include minimizing the Kullback-Leibler divergence between the joint distributions of the forward and reverse Markov chains to ensure that the reverse process effectively reconstructs or generates data that closely matches the training data. As another example, a common and computationally efficient objective is to train the model to predict the noise that was added to the data. For instance, in a typical training step, a random amount of noise is added to a clean training image. The model is then tasked with predicting that specific noise pattern from the resulting noisy image. The training objective is typically to minimize the mean squared error between the actual noise that was added and the noise predicted by the neural network. Additionally, the model can be trained to optimize the likelihood of the data given the model, which can enhance the model's ability to generate new samples that are indistinguishable from real data.

Various strategies can be used to perform the training process for diffusion models. Gradient descent algorithms, such as stochastic gradient descent (SGD) or Adam, can be utilized to update the model's parameters. Moreover, learning rate schedules can be implemented to adjust the learning rate during training, which can help in stabilizing the training process and improving convergence. For instance, a learning rate that decreases gradually as training progresses can lead to more stable and reliable model performance.

Various loss functions can be used guide the training of denoising diffusion models. Example loss functions include the mean squared error (MSE) for regression tasks or cross-entropy loss for classification tasks within the model. Additionally, variational lower bounds, such as the evidence lower bound (ELBO), can be used to train the model under a variational inference framework. These loss functions can help in quantifying the discrepancy between the generated samples and the real data, guiding the model to produce outputs that closely resemble the target distribution.

In some implementations, the randomness or stochasticity of the generation process can be controlled. This is particularly relevant in samplers like Denoising Diffusion Implicit Models (DDIM), which introduce a parameter (often denoted as eta) to control the level of stochasticity. By adjusting this parameter, one can interpolate between a fully deterministic process (which produces the same output for a given starting noise) and a fully stochastic process similar to the original DDPM formulation. A more deterministic path (eta=0) can lead to more stable and sometimes higher-fidelity samples, while a more stochastic path (eta=1) increases sample diversity at the potential cost of some quality.

In some implementations, conditional generation can allow the generation of data samples based on specific conditions or attributes. Conditional generation in denoising diffusion models can include modifying the reverse diffusion process based on additional inputs (e.g., conditioning inputs) such as class labels or text descriptions, which guide the model to generate data samples that are more likely to meet specific conditions. This can be implemented by conditioning the model on additional inputs such as class labels, text descriptions, or other data modalities. For example, in a model trained on a dataset of images and their corresponding captions, the model can generate images that correspond to a given textual description, enabling targeted image synthesis.

More particularly, denoising diffusion models can be conditioned using various types of data to guide the generation process towards specific outcomes. One common type of conditioning data is text. For example, in generating images from descriptions, the model can use textual inputs like “a sunny beach” or “a snowy mountain” to generate corresponding images. The text can be processed using natural language processing techniques to transform it into a format that the model can utilize effectively during the generation process.

For example, one type of conditioning data can include text embeddings. Text embeddings are vector representations of text that capture semantic meanings, which can be derived from pre-trained language models such as BERT or CLIP. These embeddings can provide a denser and potentially more informative representation of text than raw text inputs. For instance, in a diffusion model tasked with generating music based on mood descriptions, embeddings of words like “joyful” or “melancholic” can guide the audio generation process to produce music that reflects these moods.

Additionally, conditioning can also include using categorical labels or tags. This approach can be particularly useful in scenarios where the data needs to conform to specific categories or classes.

Classifier-free guidance is a technique that can enhance the control over the sample generation process without the need for an additional classifier model. This can be achieved by modifying the guidance scale during the reverse diffusion process, which adjusts the influence of the learned conditional model. For instance, by increasing the guidance scale, the model can produce samples that more closely align with the specified conditions, improving the fidelity of generated samples that meet desired criteria without the computational overhead of training and integrating a separate classifier.

In some implementations, denoising diffusion models can integrate with other generative models to form hybrid models. For instance, combining a denoising diffusion model with a Generative Adversarial Network (GAN) can leverage the strengths of both models, where the diffusion model can ensure diversity and coverage of the data distribution, and the GAN can refine the sharpness and realism of the generated samples. Another example can include integration with Variational Autoencoders (VAEs) to improve the latent space representation and stability of the generation process.

Efficiency improvements are beneficial aspects of denoising diffusion models. One way to achieve this is by reducing the number of diffusion steps required to generate high-quality samples. For example, sophisticated training techniques such as curriculum learning can be employed to gradually train the model on easier tasks (fewer diffusion steps) and increase complexity (more steps) as the model's performance improves. Additionally, architectural optimizations such as implementing more efficient neural network layers or utilizing advanced activation functions can decrease computational load and improve processing speed during both training and generation phases.

Noise scheduling strategies can improve the performance of denoising diffusion models. By carefully designing the noise schedule—the variance of noise added at each diffusion step—models can achieve faster convergence and improved sample quality. For example, using a learned noise schedule, where the model itself optimizes the noise levels during training based on the data, can result in more efficient training and potentially better generation quality compared to fixed, predetermined noise schedules.

In some implementations, learned upsampling in denoising diffusion models can facilitate the generation of high-resolution outputs from lower-resolution inputs. This technique can be particularly useful in applications such as high-definition image generation or detailed audio synthesis. Learned upsampling can include additional model components that are trained to increase the resolution of generated samples through the reverse diffusion process, effectively enhancing the detail and quality of outputs without the need for externally provided high-resolution training data. In some cases, these additional learned components can be referred to as “super-resolution” models.

In some implementations, denoising diffusion models can be applied to the field of image synthesis, where they can generate high-quality, photorealistic images from a distribution of training data. For example, example models can be used to create new images of landscapes, animals, or even fictional characters by learning from a dataset composed of similar images. The model can add noise to these images and then learn to reverse this process, effectively enabling the generation of new, unique images that maintain the characteristics of the original dataset.

Denoising diffusion models can also be utilized in audio generation. They can generate clear and coherent audio clips from noisy initial data or even from scratch. For instance, in the music industry, example models can help in creating new musical compositions by learning from various genres and styles. Similarly, in speech synthesis, denoising diffusion models can generate human-like speech from text inputs, which can be particularly beneficial for virtual assistants and other AI-driven communication tools.

Other potential use cases of denoising diffusion models extend across various fields including drug discovery, where example models can help in generating molecular structures that could lead to new pharmaceuticals. Additionally, in the field of autonomous vehicles, denoising diffusion models can be used to enhance the processing of sensor data, improving the vehicle's ability to interpret and react to its environment.

In some implementations, the performance of denoising diffusion models can be evaluated using various metrics that assess the quality and diversity of generated samples. The Inception Score (IS) is one such metric that can be used; it measures how distinguishable the generated classes are and the confidence of the classification. For example, a higher Inception Score indicates that the generated images are both diverse across classes and each image is distinctly recognized by a classifier as belonging to a specific class. Another commonly used metric is the Frechet Inception Distance (FID), which assesses the similarity between the distribution of generated samples and real samples, based on features extracted by an Inception network. A lower FID indicates that the generated samples are more similar to the real samples, suggesting higher quality of the generated data.

Referring still to FIG. 5A, the user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 5A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 5B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 5B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 5C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 5C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 5C, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for performing virtual try-on with split classifier-free guidance, the method comprising:
for each of one or more diffusion timesteps:
processing, by a computing system comprising one or more computing devices, a noisy input associated with the diffusion timestep with a machine-learned diffusion model to generate an initial prediction;
setting, by the computing system, a current prediction equal to the initial prediction;
for each of a plurality of update iterations respectively associated with a plurality of sets of one or more conditioning inputs:
processing, by the computing system, the noisy input with the machine-learned diffusion model conditioned on the set of one or more conditioning inputs associated with the current update iteration to generate a conditioned prediction; and
updating, by the computing system, the current prediction based on the conditioned prediction associated with the current update iteration; and
providing, by the computing system, an output image based on the current prediction, wherein the output image depicts a person wearing a garment.

2. The computer-implemented method of claim 1, wherein:
the method further comprises obtaining a plurality of weights respectively associated with the plurality of sets of one or more conditioning inputs; and
updating, by the computing system, the current prediction based on the conditioned prediction comprises updating, by the computing system, the current prediction based on the conditioned prediction and according to the weight associated with the set of one or more conditioning inputs.

3. The computer-implemented method of claim 1, wherein updating, by the computing system, the current prediction based on the conditioned prediction comprises:
determining, by the computing system, a weighted difference between the conditioned prediction associated with the current update iteration and the conditioned prediction associated with a prior preceding update iteration; and
adding, by the computing system, the weighted difference to the current prediction.

4. The computer-implemented method of claim 1, wherein:
the noisy input image a plurality of noisy inputs and the output image comprises a plurality of output images;
the plurality of output images depict the person wearing the garment in motion; and
the machine-learned diffusion model comprises a video diffusion model.

5. The computer-implemented method of claim 1, wherein each of the plurality of update iterations comprises adding the set of one or more conditioning inputs to an active set of conditioning inputs.

6. The computer-implemented method of claim 1, wherein the plurality of sets of one or more conditioning inputs comprise:
a set of one or more clothing-agnostic images that depict the person agnostic of clothing;
a set of one or more garment conditioning inputs that describe the garment; and
a set of one or more pose or mask inputs associated with the person.

7. The computer-implemented method of claim 6, wherein the set of one or more garment conditioning inputs comprise segmentation, pose, and mask inputs associated with the garment.

8. The computer-implemented method of claim 6, wherein the plurality of sets of one or more conditioning inputs are added and processed by the model in the following order: (i) the set of one or more clothing-agnostic images that depict the person agnostic of clothing; (ii) the set of one or more garment conditioning inputs that describe the garment; and (iii) the set of one or more pose or mask inputs associated with the person.

9. One or more non-transitory computer-readable media that collectively store:
a machine-learned video diffusion model configured to generate video virtual try-on outputs,
wherein the machine-learned video diffusion model comprises one or more diffusion transformer blocks,
wherein the machine-learned video diffusion model comprises a temporally inflated model comprising one or more temporal mixing layers and one or more temporal attention layers,
wherein the machine-learned video diffusion model comprises a garment encoder configured to encode one or more garment images that depict a garment, and
wherein the machine-learned video diffusion model comprises a person encoder configured to encode a plurality of person images that depict a person; and
instructions that, when executed by the one or more processors, cause the one or more processors to perform operations, the operations comprising:
obtaining the one or more garment images and the plurality of person images; and
processing a noisy input with the machine-learned video diffusion model conditioned on the one or more garment images and the plurality of person images to generate a plurality of output images, wherein the plurality of output images depict the person wearing the garment in motion.

10. The one or more non-transitory computer-readable media of claim 9, wherein the machine-learned video diffusion model has been trained using a progressive temporal training technique in which the number of output images is increased as training progresses.

11. The one or more non-transitory computer-readable media of claim 9, wherein the machine-learned video diffusion model has been trained using a joint image and video training technique in which the machine-learned video diffusion model is jointly trained on both image batches and video batches.

12. A computing system for training a diffusion model for virtual video try-on, the computing system comprising:
one or more processors; and
one or more non-transitory computer-readable media that collectively store computer-executable instructions for performing operations, the operations comprising:
first training the diffusion model to generate denoised single images;
second training, over a plurality of training epochs, the diffusion model to generate videos comprising multiple denoised images;
wherein, for at least one of the plurality of training epochs, a number of denoised images contained in the generated videos is increased relative to the previous training epoch.

13. The computing system of claim 12, wherein a length of the generated videos is increased over the plurality of training epochs from 8 to 16 to 64.

14. The computing system of claim 12, wherein the first training to generate denoised single images comprises a batch size greater than one and wherein the second training to generate videos comprises a batch size of 1.

15. The computing system of claim 12, wherein the second training further comprises interspersed epochs of training the diffusion model to generate denoised single images.

16. The computing system of claim 12, wherein one or both of said first training and said second training comprises training operations comprising:
for each of one or more diffusion timesteps:
processing, by the computing system, a noisy input associated with the diffusion timestep with a machine-learned diffusion model to generate an initial prediction;
setting, by the computing system, a current prediction equal to the initial prediction;
for each of a plurality of update iterations respectively associated with a plurality of sets of one or more conditioning inputs:
processing, by the computing system, the noisy input with the machine-learned diffusion model conditioned on the set of one or more conditioning inputs associated with the current update iteration to generate a conditioned prediction; and
updating, by the computing system, the current prediction based on the conditioned prediction associated with the current update iteration; and
providing, by the computing system, an output image based on the current prediction, wherein the output image depicts a person wearing a garment.

17. The computing system of claim 16, wherein:
the training operations further comprise obtaining a plurality of weights respectively associated with the plurality of sets of one or more conditioning inputs; and
updating, by the computing system, the current prediction based on the conditioned prediction comprises updating, by the computing system, the current prediction based on the conditioned prediction and according to the weight associated with the set of one or more conditioning inputs.

18. The computing system of claim 16, wherein updating, by the computing system, the current prediction based on the conditioned prediction comprises:
determining, by the computing system, a weighted difference between the conditioned prediction associated with the current update iteration and the conditioned prediction associated with a prior preceding update iteration; and
adding, by the computing system, the weighted difference to the current prediction.

19. The computing system of claim 16, wherein:
the noisy input image a plurality of noisy inputs and the output image comprises a plurality of output images;
the plurality of output images depict the person wearing the garment in motion; and
the machine-learned diffusion model comprises a video diffusion model.

20. The computing system of claim 16, wherein each of the plurality of update iterations comprises adding the set of one or more conditioning inputs to an active set of conditioning inputs.
